(19) United States
(12) Patent Application Publication
(10) Pub. No.: US 2010/0308666 A1
(43) Pub. Date: Dec. 9, 2010

(54) ELECTRIC RANGE SAFETY SHUT-OFF

(76) Inventor: Myron Todd Raby, Hudson, NC (US)

Correspondence Address: PASSE' INTELLECTUAL PROPERTY, LLC, 1717 BRASSFIELD RD., RALEIGH, NC, 27614, US

(21) Appl. No.: 12/481,227

(22) Filed: Jun. 9, 2009

(51) Int. Cl. H01H 27/06

(52) U.S. Cl. 307/142

(57) ABSTRACT

The present invention relates to a safety shut-off device for an electric range. The device comprises a keyed lock for engaging the device and a relay for interrupting power across the power feed lines.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a safety shut-off device for an electrical range. In particular the present invention relates to a device and method for shutting off an electric range should the range be in the presence of an unsupervised incompetent person.

2. Description of Related Art

The use of a dangerous electric household appliance by the elderly, children, infirm, other unauthorized individuals and the like can be potentially hazardous. The operation of a stove for instance by such persons can easily cause a fire and lead to loss of life. It is advantageous to control these devices when they are turned on. There are many devices which prevent the initial operation of an electrical device, such as locked up receptacles and other devices, which provide a means for turning the power to the stove on or off. Other devices require a removable key pad or the like to lock the stove and thus, both a number key code as well as needing to attach a key pad for use must be accomplished before using the device. The keypads require their own power system, can be easily lost and have very high replacement costs.

### BRIEF SUMMARY OF THE INVENTION

The present invention relates to a means for controlling the power to an electric stove. In particular it has been discovered that a relay with a switch that is operated by a removable key provides safety, ease of use and reasonable cost in controlling the use of a stove by non-competent individuals. While the device doesn't relieve the incompetent state of an individual, it can be used to prevent the use by such individuals. The device consists of a means to connect to power, a receptacle to plug the stove into, a relay to control turning off the power to the stove and a key operated switch for engaging the relay into a closed position for allowing electricity to reach the stove through the device.

Accordingly, the present invention relates to an AC electric range safety shut-off device for use with a 2 phase AC power source having two load lines comprising:
a) an AC electrical receptacle for connecting the electric range;
b) a connector for connecting the shut-off device to the AC 2 phase electrical power source;
c) a relay in line between the connector and the device receptacle wired across both load lines; and
d) an electrical power on/off switch operated by a removable key that engages the connection of the relay across the load lines;
wherein upon the key engaging the off position, the relay cuts the power connection across both load lines.

The present invention overcomes the many problems with the prior art means of controlling electrical devices and has various embodiments as can be seen from the drawings and claims which follow.

### BRIEF DESCRIPTION OF THE DRAWINGS

FIG. 1 is a schematic of an embodiment of the invention connected to a 220V electric stove with a key operated switch and key with indicator light embodiment depicted.

FIG. 2 is a perspective view of an embodiment of the present invention showing the various parts of the invention.

FIG. 3 is a perspective view of one embodiment of the present invention installed with an electric stove, but could be applied to other appliances or devices.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”,“certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein an “electric range” refers to an electric range or stove with a two phase power source. In other words, one having two load lines powering the range. In the United States that is usually 220V current but other alternating current ranges could be used where 220 is not available. Typically, the power line for such appliances consist of a first and second load line, a neutral line and a ground line. The power source is normally provided by a female receptacle such as a 220V female receptacle. Power will come from any power source, such as from the local power utility or from spot generated electricity, such as from a generator or the like.

As used herein the phrase “safety shut-off” refers to a keyed on/off device which will, upon turning the key, disconnect the power source from the electrical range should the competent person decide to leave the appliance unattended or determine the need to have the range in a non-operable state. An “ac electrical receptacle” refers to a 2 phase load line, such as a 220V female receptacle for plugging in an electric range using 220V 2 phase and having a corresponding male 2 phase plug.

As used herein the term “relay” refers to an electro-magnetic switching device used for remotely switching a power or control circuit. In one embodiment of the present invention the relay is a contactor relay. A contactor is activated by a control input which is a lower voltage and current than that which the contactor is switching. The relay is a 2 phase relay for wiring across both load lines of a 2 phase power source. In the case of a contactor relay, the relay is fused at the main panel such that it will trip open the relay should the preselected predetermined amperage be exceeded. When the relay is tripped, the relay cuts the connection across both load lines simultaneously. The selected relay would be matched to the amperage load lines of the power source. For example, where a 50a 220v circuit is being used a 40 amp, 2 pole contactor with 120 volt coil could be used with the fuse. One skilled in the art in view of this disclosure could easily pick other contactor relays in accordance with the performance of the invention herein. The fuse contained within the switch leg could be a replaceable type fuse or could be a reusable circuit breaker type fuse as desired. If the fuse on the switch leg opens, the range and relay will be disabled until such fuse is replaced or circuit breaker is reset. The relay can be reactivated after being tripped by replacing the fuse or resetting the circuit breaker.

In addition to the relay, the power circuit which comprises the present invention has a key operated switch. The key operated switch has a removable key for either leaving the circuit in a closed position for engaging the circuit or an open position such that the range cannot be used since the switch leaves the entire circuit in an open position. The advantage to a keyed switch rather than a switch or a keypad type switch is that it is inexpensive, easy to operate and the key can be removed to prevent unwanted use. In addition multiple copies of the key can be used such that multiple users of the range can each operate the range without the others. The key operated switch can also have wired thereto an indicator lamp that indicates when power is live to make it clear when the circuit to the range is active and the range can be used. A simple lamp or LED could be used for this purpose.

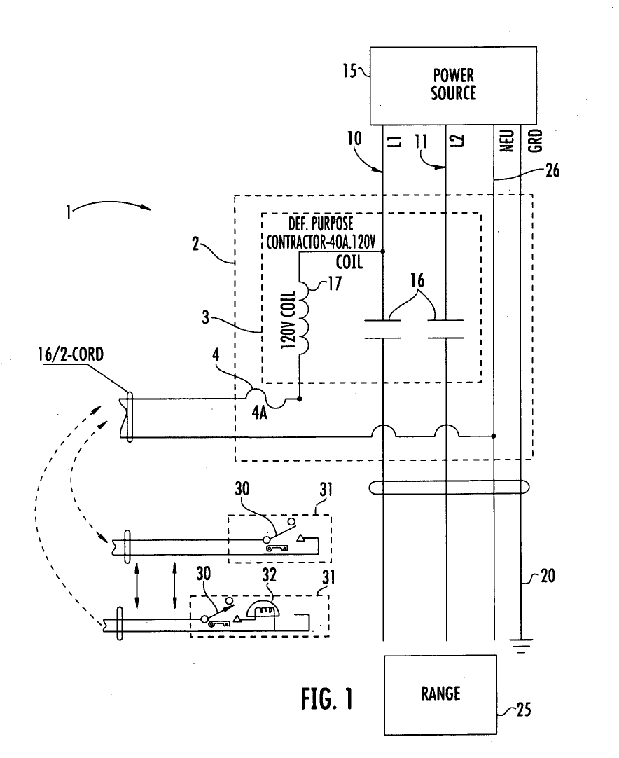

Now referring to the drawings, FIG. 1 depicts a schematic of an embodiment of the invention connected to a 220V electric stove with a key operated switch and key with an indicator light embodiment depicted.

In this schematic the shut-off device 1 consists of an enclosure 2 having a relay 3 and a fuse 4 connected to load lines L1 10 and L2 11 which in turn is connected to power source 15. The relay 3 consists of load line cut offs 16 and 120V coil 17. The enclosure 2 also consists of a line out 20 which is connected to range 25 by a female connector (not shown) or any other general way of connecting to the range 25.

The fuse 4 in the enclosure 2 is wired in series with the coil 26 to a key operated switch 30. In this embodiment, the keyed switch 30 is enclosed in shut-off enclosure 31. Two separate embodiments of the switch are shown one with indicator lamp 32. Either of the two switches (but not both) are connected to the relay 3. The power indicator light 32 indicates when current is flowing and thus, the appliance is usable.

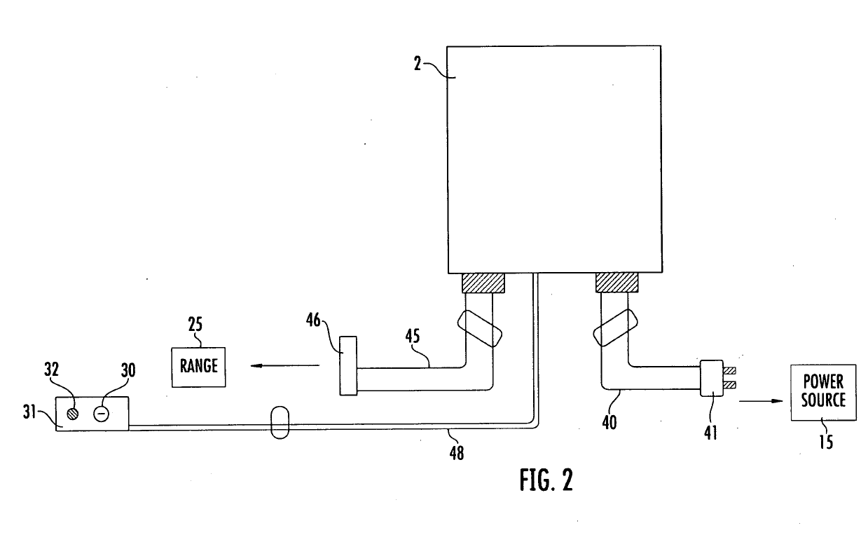

FIG. 2 depicts a perspective view of an embodiment of the present invention, enclosure 2 consisting of the relay and fuse shown in the previous figures, has connecting line 40 with male plug 41 for connecting to a power source 15 having a female connection receptacle. The enclosure 2 also has connecting line 45 with female receptacle 46 for connecting a range 25 having a male connecting plug. Also depicted, is line 48 with shut-off enclosure 31 with key operated switch 30 and indicator light 32.

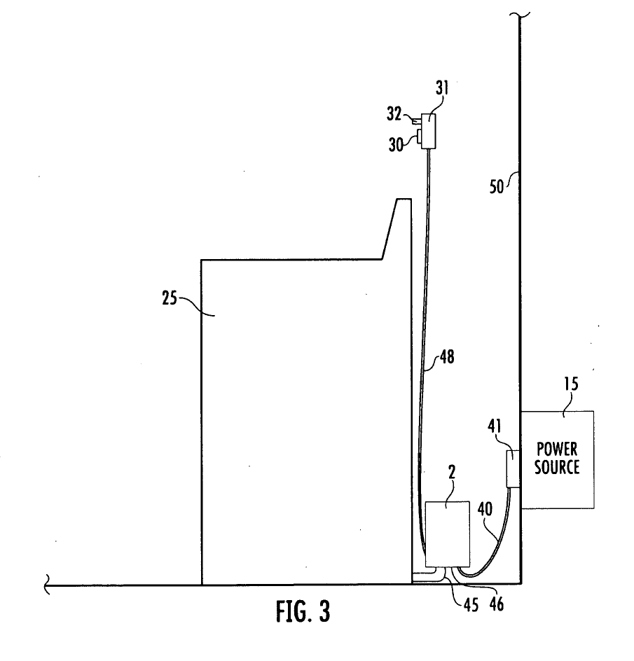

FIG. 3 depicts the present invention connected to stove 25. In this embodiment the shut-off enclosure 30 is depicted as in mid air but it could be attached to wall 50, to the range 25 or just be loose. The plug 41 is shown plugged into power source 15 and positioned behind range 25. By positioning the device behind the range 25 it is less likely that the device could be manually disengaged. In one embodiment, the range plug could be locked inside enclosure 2 so that if the range 25 is moved it would be difficult or impossible to unplug the range 25 from the device 1.

It is clear that various embodiments in amperage, voltage and the like are possible even though the 2 phase device is depicted as 220V. Other embodiments are clear from the disclosures and drawings herein and are included in the scope of the claims which follow.

What is claimed is:

1. An AC electric range safety shut-off device for use with a 2 phase AC power source having two load lines comprising:
a) an AC electrical receptacle for connecting the electric range;
b) a connector for connecting the shut-off device to the AC 2 phase electrical power source;
c) a relay in line between the connector and the device receptacle wired across both load lines; and
d) an electrical power on/off switch operated by a removable key that engages the connection of the relay across the load lines;
wherein upon the key engaging the off position, the relay cuts the power connection across both load lines.

2. A shut-off device according to claim 1 which further comprises an indicator light for indicating if there is power to the stove.

3. A shut-off device according to claim 1 which further comprises an inline fuse which is capable of shutting off the power to the stove in the event of a current spike within the control switch leg.

4. A shut-off device according to claim 1 wherein the fuse is a 1 to 2 amp fuse.

5. A shut-off device according to claim 1 wherein the relay is a contactor relay.

6. A shut-off device according to claim 5 wherein the contactor relay is a 40 amp, 2 pole contactor with 120 volt coil.

7. A shut-off device according to claim 1 wherein the relay is housed in a safety enclosure.

8. A shut off device according to claim 7 wherein the fuse is contained within the enclosure.
